(19) United States
(12) Patent Application Publication
(10) Pub. No.: US 2007/0174610 A1
(43) Pub. Date: Jul. 26, 2007

(54) Security policy assignment apparatus and method and storage medium stored with security policy assignment program

(76) Inventors: Hiroshi Furuya, Kawasaki-shi (JP); Takanobu Suzuki, Kawasaki-shi (JP); Hiromi Ohara, Kawasaki-shi (JP); Takayuki Kubodera, Kawasaki-shi (JP); Yutaka Agawa, Ebina-shi (JP)

Correspondence Address: GAUTHIER & CONNORS, LLP, 225 FRANKLIN STREET, SUITE 2300, BOSTON, MA, 02110, US

(21) Appl. No.: 11/482,144

(22) Filed: Jul. 6, 2006

(30) Foreign Application Priority Data
Jan. 25, 2006 (JP) 2006-16189

(51) Int. Cl. H04L 9/00; G06F 12/14; G06F 17/00; H04L 9/32; H04K 1/00; G06F 11/30; G06F 17/30; G06F 7/04; G06K 9/00; H03M 1/68; H04N 7/16

(52) U.S. Cl. 713/167; 726/1; 713/165; 713/193; 726/27; 726/28

(57) ABSTRACT

A security policy assignment apparatus includes an acquisition unit that acquires data relating to a storage location of a digital document and an assignment unit that assigns a security policy, which has been set to correspond to data relating to the acquired storage location, with respect to the digital document by referencing correspondence data that maps data relating to the storage location and a security policy setting.

### BACKGROUND

1. Technical Field

The present invention relates to a technology for assigning a security policy to a digital document.

2. Related Art

As the network environment develops in recent years, the digitizing of documents for a paperless office is progressing. For example, when transmitting information in an office, a digital document is created on a PC (personal computer) and distributed. However, offices even now have large quantities of paper documents that have not been digitized as well as digital documents that have not been assigned a security policy.

### SUMMARY

According to an aspect of the invention, a security policy assignment apparatus includes an acquisition unit that acquires data relating to a storage location of a digital document and an assignment unit that assigns a security policy, which has been set to correspond to data relating to the acquired storage location, with respect to the digital document by referencing correspondence data that maps data relating to the storage location and a security policy setting.

### BRIEF DESCRIPTION OF THE DRAWINGS

Embodiments of the present invention will be described in detail based on the following figures, wherein:

FIG. 1 schematically shows a configuration example of a policy assignment system;

FIG. 2 is a sequence chart showing the flow of processing when a paper document is scanned;

FIG. 3 is a sequence chart showing the flow of processing for an existing digital document;

FIG. 4 shows an example of a directory structure storing digital documents;

FIG. 5 is a correspondence table between the storage directory and security policy;

FIG. 6 shows example settings of access privileges for storage directories;

FIG. 7 is a flowchart showing the flow of processing when a paper document is scanned; and

FIG. 8 is a flowchart showing the flow of processing for an existing digital document.

### DETAILED DESCRIPTION

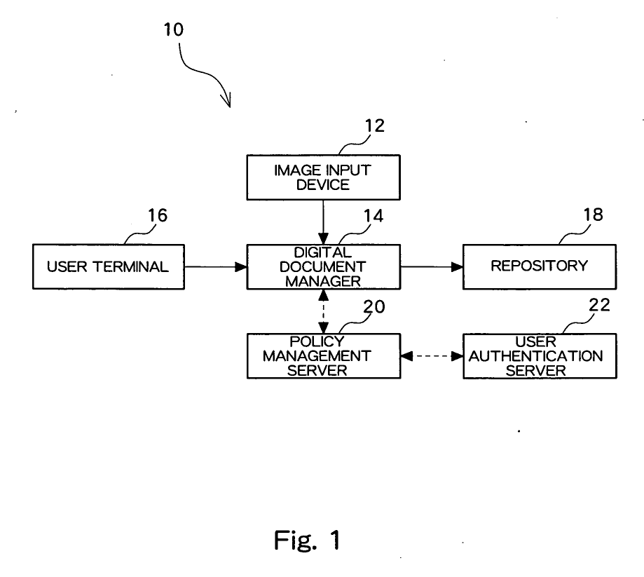

FIG. 1 is a block diagram schematically showing a configuration of a policy assignment system 10 relating to an embodiment. The policy assignment system 10 includes an image input device 12, a digital document manager 14, a user terminal 16, a repository 18, a policy management server 20, and a user authentication server 22. These components may be constructed as an integrated processing system within a single device or as a distributed processing system that is connected, for example, through a network.

The image input device 12 generates a digital document (typically a digital image created in a raster format) from a paper document and is constructed, for example, from a scanner or a multifunction device (equipped with scanner, printer, and facsimile functions). The image input device 12 generates a digital document from a paper document and transmits the digital document to the digital document manager 14. In the stage where the digital document is generated, the digital document is not usually set with a security policy.

The digital document manager 14 is the core of the policy assignment system 10 and is equipped with functions, such as a function to store a digital document, which is input from the image input device 12, to an appropriate storage location in the repository 18, a function to assign a security policy to the digital document, and a function to manage the digital document according to the security policy. When storing the digital document into the repository 18, the storage location may be determined according to pre-programmed settings or may be determined according to user command that is sent from the image input device 12. Furthermore, functions for assigning a security policy include a function for acquiring policy information that is data relating the storage location (current storage location or planned storage location) of a digital document, a function for determining a security policy on the basis of mapping information between policy information and security policy element value, and a function for performing encryption of the digital document on the basis of the determined security policy. Furthermore, functions that perform management according to security policy can include a function for judging whether or not to permit access to a digital document when there is an access request to the digital document by issuing an inquiry to the policy management server 20 regarding user operating privileges based on the security policy. To implement this function, the digital document manager 14 is constructed using a computer that includes hardware with arithmetic and control functions and software for defining their operations, such as a PC (personal computer) and a multifunction device that may or may not be identical to the image input device 12. The digital document manager 14 is connected to the image input device 12 and inputs digital documents and user commands from the image input device 12. Furthermore, the digital document manager 14 is also connected to the user terminal 16 and inputs user commands via the user terminal 16.

On the basis of user operations, the user terminal 16 issues commands to the digital document manager 14 for the generation, storage, and printing of digital documents. The user can issue a command via the user terminal 16 to set a security policy for a digital document that has already been stored in the repository 18 and not been set with a security policy. The user terminal 16 can be constructed from various devices on a network, such as a PC or a multifunction device.

The repository 18 is a device for storing digital documents before or after the digital document manager 14 has assigned a security policy. A digital document that has been assigned a security policy may be encrypted so as not to be manipulated by any unauthorized third party. The repository 18 can be constructed by using a storage device that is accessible from the digital document manager 14. Specific examples of a storage device include a file server connected to the digital document manager 14, a local storage of the image input device 12, a local storage of the user terminal 16, a file server on the Internet, a P2P (Peer to Peer) shared file area, and so forth.

The policy management server 20 is positioned to be accessible from the digital document manager 14 and manages the security policy that has been assigned to a digital document. A security policy determines the limits of various operating privileges with respect to a digital document, such as display, editing, copying, and printing, and can be set for every digital document and for every user. The security policy that is set by the policy management server 20 includes storage location and identification information of each digital document as well as information on user operating privileges for each type of operation. Furthermore, as necessary, also included is information specifying the operation that was performed to protect a digital document, such as encryption information for the digital document.

The user authentication server 22 is positioned to be accessible from the policy management server 20 and authenticates a user who is logging in or performing an operation with respect to the policy assignment system 10. If the policy assignment system 10 forms a distributed system, user authentication at each device or component can be performed in a batch process by using the user authentication server 22.

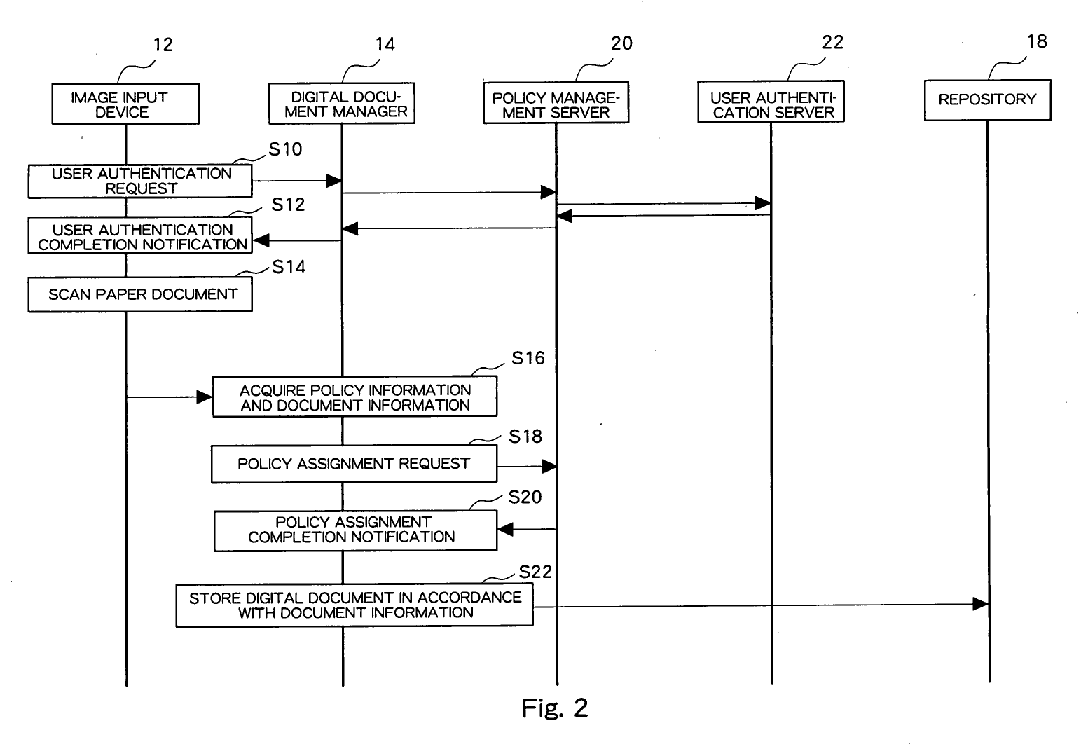

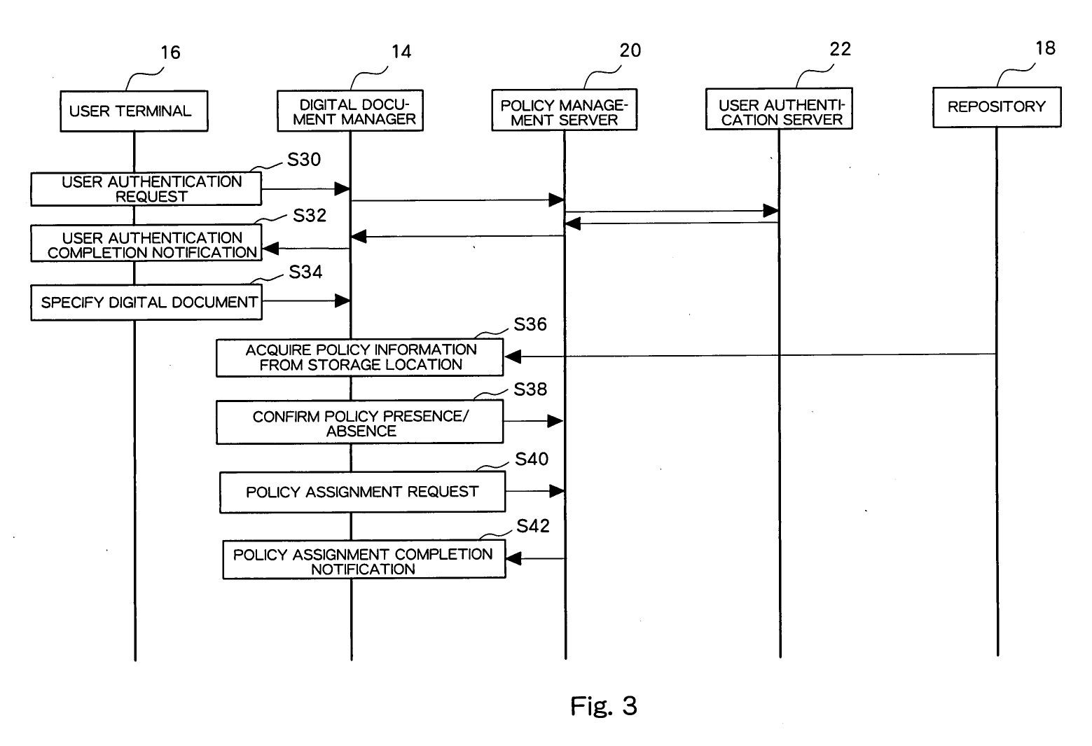

Next, an operation of the policy assignment system 10 of FIG. 1 will be described using the UML (Unified Modeling Language) sequence charts of FIG. 2 and FIG. 3.

FIG. 2 describes the flow of processing when a paper document is scanned to generate a digital document and a security policy is assigned to the digital document. In this case, a user attempts to log in by entering a user name and password from the operating panel of the image input device 12. Then, the entered user name and password information is sent from the image input device 12 to the user authentication server 22 via the digital document manager 14 and the policy management server 20 and authenticated (S10) by the user authentication server 22. The authenticated information is transferred (S12) to the image input device 12 via the policy management server 20 and the digital document manager 14 and displayed on the operating panel.

The user next places the paper document on the image input device 12 and performs scanning. At this time, due to a standard setting or user command, a command is issued to specify the processing mode of the digital document to be generated (whether to store and into which mailbox in the repository 18, whether to print out, whether to perform a facsimile transmission, and so forth) or specify whether or not to assign a security policy to the digital document to be generated. At the image input device 12, the paper document is scanned and a digital document is created (S14) and transmitted to the digital document manager 14.

If the generated digital document is stored into a mailbox and a security policy is assigned on the basis of the storage location, the digital document manager 14 first acquires (S16) policy information and document information from the acquired digital document. The document information includes information necessary for the storage of the digital document, such as storage location (repository name, directory name (mailbox name), and so forth) and storage document name. Although the document information is typically acquired on the basis of a user command that is input from the image input device 12, it can, for example, also be acquired from the digital document. As examples of the latter case, the acquisition can be performed from characters or images forming the digital document, metadata of the digital document, characters or images forming another digital document generated from scanning and mapping the digital document, and so forth. Furthermore, the policy information includes data to be keywords for setting the security policy and maps to the storage location of the digital document. Namely, the policy information, once set, is mapped to some or all security policy element values so as to determine at least part of the security policy and includes information on the identification name of the storage location, attribute assigned to the storage location (identification name of the owner and setting for access to the storage location), and so forth. The acquisition of the policy information, for example, may be performed in a similar manner to the document information or performed on the basis of information on the storage location in the document information.

The digital document manager 14 determines the setting for the security policy to be assigned from the acquired policy information in accordance with the correspondence relation that has been set in advance. Then, a command is issued (S18) with respect to the policy management server 20 to set the determined security policy to the digital document. At the policy management server 20, the security policy is stored with the document information of the digital document and a report thereof is issued (S20) to the digital document manager 14. Furthermore, the digital document manager 14 encrypts the digital document as necessary, and then stores (S22) the digital document into the repository 18 in accordance with the document information.

In this manner, the conversion of a paper document into a digital document and the setting of a security policy for the digital document are performed. In this mode, once a rule for security setting has been determined, the user can create a large quantity of digital documents that have been set with a security policy without having to be particularly conscious about setting a security policy. Therefore, for example, a large quantity of paper documents in an office can be easily quickly and easily converted into digital documents.

Next, a modification of the example shown in FIG. 2 will be described using FIG. 3. FIG. 3 shows the flow of processing when setting a security policy for a digital document that is stored in the repository 18.

In this example, the user operates the user terminal 16 and attempts to log in to the digital document manager 14. The digital document manager 14 sends a request (S30) for user authentication to the user authentication server 22 via the policy management server 20 and the user authentication result is transmitted (S32) to the user terminal 16 via the policy management server 20 and the digital document manager 14.

A digital document to be set with a security policy is specified (S34) from the user terminal 16 for the digital document manager 14. In this process, the storage location is also specified so that the digital document can be specified. Furthermore, when a storage location is specified, some or all digital documents in that location may be automatically specified.

The digital document manager 14 acquires (S36) policy information relating to the specified digital document from the repository 18 and sets a security policy on the basis of this policy information. Furthermore, the digital document manager 14 confirms (S38) with respect to the policy management server 20 whether or not a security policy has already been set for the digital document. In the case where a security policy has already been set, a setting is not performed or a setting is performed so as not to contradict the security policy that has already been set. On the other hand, if a security policy has not been set, the digital document manager 14 performs a new security policy setting (S40) with respect to the policy management server 20. Then, the policy management server 20 notifies (S42) the digital document manager 14 that the assignment of the security policy has completed. If it is necessary to encrypt the digital document for the security policy setting, the relevant command is sent to the repository 18.

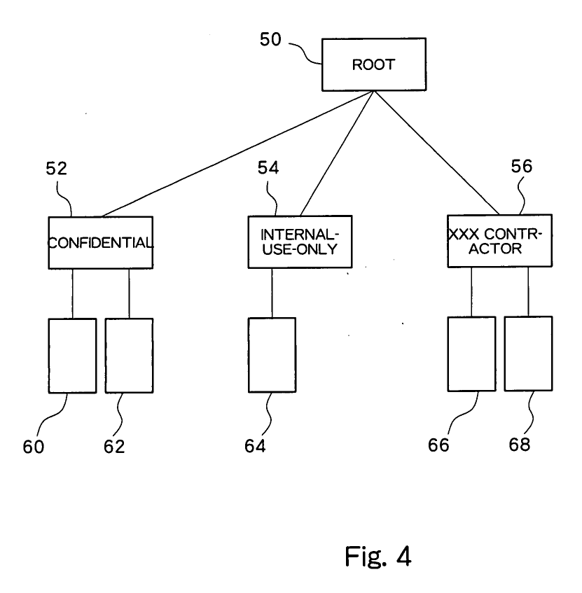

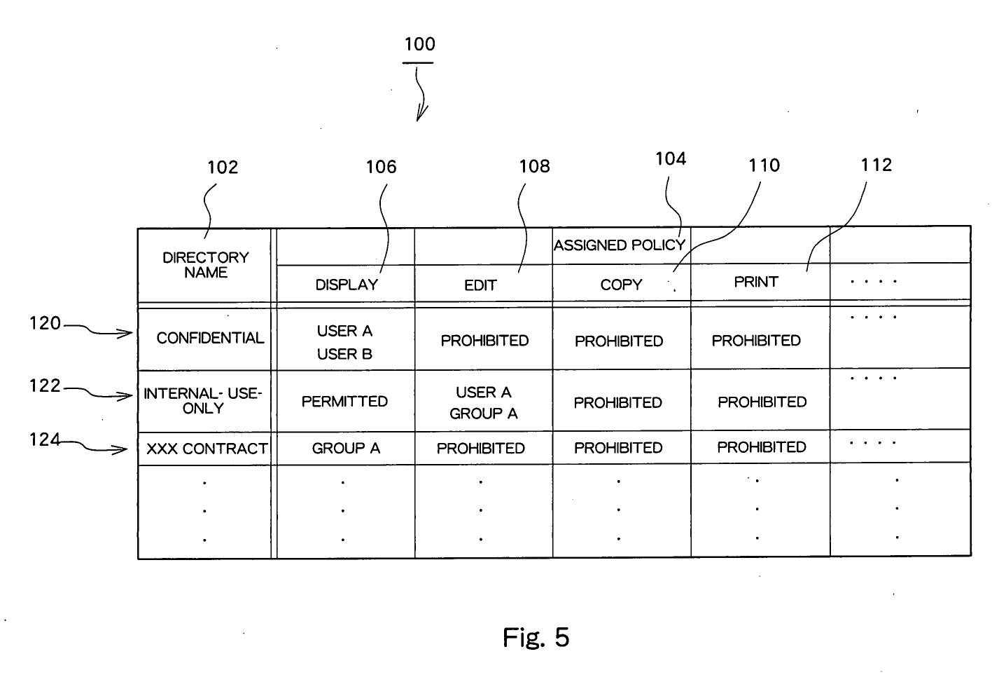

A specific example for assigning the security policy on the basis of the storage location of the digital document will be described using FIG. 4 and FIG. 5.

FIG. 4 shows an example of a structure of storage locations of digital documents. A hierarchical directory (also may be referred to as mailboxes or folders) has been constructed for storing digital documents. More specifically, the structure includes a root directory 50 as a topmost level under which are a confidential directory 52, a internal-use-only directory 54, and a XXX contractor directory 56. Digital documents 60, 62 having file formats are stored in the confidential directory 54, a digital document 64 is stored in the internal-use-only directory 54, and digital documents 66, 68 are stored in the XXX contractor directory 56.

The storage location of a digital document is determined by directory structure. In the example shown, each directory name is unique in the entire directory so that the directory name itself can represent the storage location. Furthermore, if there are duplicate directory names, a storage location can be specified using a relative path or an absolute path.

Information on a storage location that is specified is used as policy information as described using FIG. 2 and FIG. 3. Namely, information on the storage location of a digital document is adopted as information for setting security policy content. A storage location is generally set to reflect the nature of the digital document. In the example of FIG. 4, one can guess confidential digital documents are stored in the confidential directory 52, as its name indicates. One can further expect digital documents for internal use only are stored in the for-internal-use directory 54 and contracts are stored in the XXX contract directory 56. Thus, it is effective to assign a security policy by reflecting information characteristic of the storage location, such as the directory name, with respect to a digital document to be stored in the respective directory.

FIG. 5 shows an example of correspondence data that maps policy information and security policy element values. In the figure, the correspondence data is designated a correspondence table 100. The correspondence table 100 is provided with a directory name column 102 for representing policy information and an assigned policy column 104 for representing corresponding element values. The assigned policy column 104 is subdivided into a display column 106, an edit column 108, a copy column 110, and a print column 112 to represent the respective operations.

A row 120 shows security policy values when a “confidential” directory is set in the directory name column 102. More specifically, a security policy is set to permit the execution of display operations only by “user A” and “user B” and prohibit the execution of editing, copying, and printing operations by all users. Similarly, according to a row 122 when the “internal use only” directory is set as policy information, a security policy is set to permit the execution of display operations by all users, to permit the execution of editing operations only by “user A” and “group A”, and to prohibit the execution of copying and printing operations by all users. Furthermore, according to a row 124 when “XXX contract” is set as policy information, a security policy is set to permit the execution of display operations by group A and to prohibit the execution of editing, copying, and printing operations by all users.

The correspondence table 100 is set in advance to the digital document manager 14 shown in FIG. 1. Then, during the security policy setting, the digital document manager 14 searches the directory name column 102 of the correspondence table 100 using the acquired policy information as a keyword and reads the corresponding value. Each entry in the correspondence table 100 may be positioned anywhere provided it is created so it can be mapped to the respective policy information. For example, when a document is stored in a directory corresponding to policy information, the security policy value can be directly acquired from the directory or storage location. The correspondence table 100 is normally created on the basis of user command. However, to lighten the burden on the user, for example, the provision of an automatic creation function can be considered to be effective, where the set mode of the digital document that has already been set with a security policy is analyzed to yield a setting rule which is proposed to the user.

In the example that was described using FIG. 4 and FIG. 5, a security policy was set according to the directory name of the storage location. However, it is also effective to assign a security policy on the basis of related information other than the identification name of the storage location. One example of this related information is access privilege information that is set to the storage location.

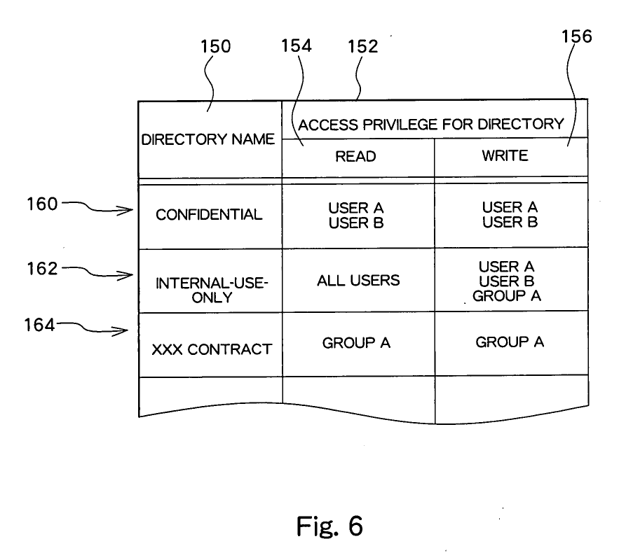

FIG. 6 shows in a tabular format the access privileges that are set for each directory. The table that is shown is provided with a directory name column 150 and an access privilege for directory column 152, with the latter further divided into a read column 154 and a write column 156. A row 160 shown for the confidential directory is set to permit reading only by user A and user B and writing only by user A and user B for (files in) this directory. The read privilege permits one to look at whether a digital document exists within the directory and generally permits the perusing of digital documents within the directory. Furthermore, the write privilege permits, for example, the creation of a new digital document within the directory and the modification and deletion of existing digital documents within the directory, provided there are no settings for exceptions. Similarly, the internal-use-only directory of a row 162 is set to permit reading by all users and writing by user A, user B, and group A, and the XXX contract directory of a row 164 is set to permit reading and writing only by group A.

It is effective to assign a security policy for a digital document in a directory based on this access privilege. As a simple example, display, copying, and printing privileges in a security policy are set based on the read privilege for a directory and the editing privilege in a security policy is set based on the write privilege for a directory. In this manner, a digital document, even if moved to another storage location, is protected by a security policy reflecting the access privilege for the original storage location. However, as shown in the examples of FIG. 5 and FIG. 6, when the security policy set elements are detailed compared to the access privileges for the directory, the security policy cannot be set in detail only on the basis of the access privileges. Namely, when setting a security policy in detail, it is necessary to map a one-to-many correspondence between the access privilege and security policy and it is necessary to define a correspondence method, such as adding other information or performing user commands in advance.

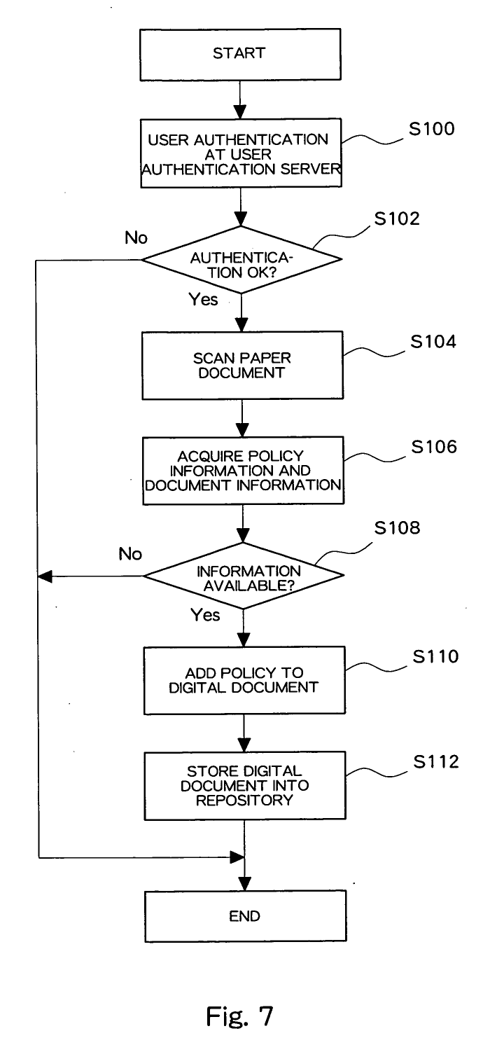

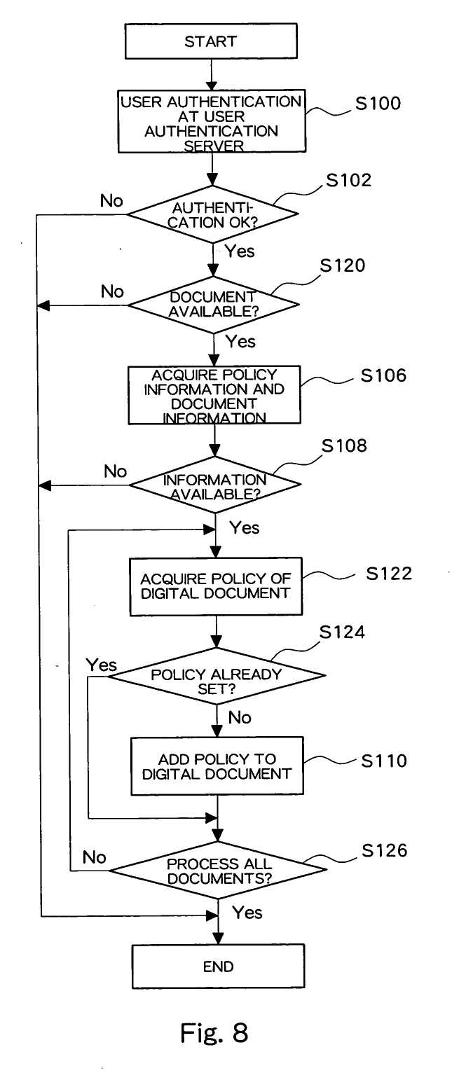

Finally, processing flows in the security policy setting will be described using the flowcharts of FIG. 7 and FIG. 8.

FIG. 7 is a flowchart showing an example of setting a security policy for a digital document that is created from scanning. In this case, the user first attempts to log in from the image input device 12 and undergoes user authentication (S100) in the user authentication server 22. User authentication can be implemented, for example, by using an LDAP (Lightweight Directory Access Protocol) server. If, as a result of the authentication (S102), the authentication fails, the processing stops, and if the authentication succeeds, continuation of the processing is allowed. In the latter case, the user issues a command (S104) to the image input device 12 to scan a paper document. At this time, the user specifies the storage destination of the digital document to be created.

As a result of the scan, the resulting digital document is sent with information of the storage destination to the digital document manager 14. The digital document manager 14 acquires (S106) policy information and document information from the received data and examines (S108) whether or not there is correspondence data for setting a security policy to correspond to the policy information. Then, if correspondence data does not exist, the processing stops, and if it exists, a security policy is created on the basis of the correspondence data and mapped to the digital document and registered (S110) into the policy management server 20. Then, the digital document is encrypted with the public key of the user having operating privileges, a process is performed to assign the information of the policy management server 20 and a characteristic document ID to the digital document, and the digital document is stored (S112) into the repository 18. The storage location is selected on the basis of the document information acquired in step S106.

Next, a mode for setting a security policy to a digital document that has already been stored will be described using FIG. 8. Processes identical to those in FIG. 7 are designated like reference numerals and their descriptions are simplified.

In this processing, after user authentication (S100, S102), the user specifies a directory storing the digital document to which a security policy is to be assigned. The digital document manager 14 examines (S120) whether or not a digital document suitable for assignment exists in the directory. If a digital document does not exist, the processing is terminated. On the hand, if a digital document exists, the document information and policy information mapped to this directory are acquired (S106). In the latter case, the mode to examine whether or not the correspondence data exists is the same as in the case of FIG. 7.

The digital document manager 14 further attempts to acquire (S122) a security policy from the policy management server 20 for each digital document stored in the directory and judges (S124) whether a security policy is present. As a result, if a security policy has already been set, the processing is terminated. If a security policy has not been set, a security policy is set with respect to the policy management server 20 and encryption of the digital document stored in the repository 18 is performed (S110). Then, it is judged whether there are any unprocessed digital documents remaining within the directory. If an unprocessed digital document is found, the processing from step S122 is repeated.

Various embodiments are summarized hereinafter. Some embodiments may overlap with the aforementioned descriptions.

The security policy assignment apparatus can be constructed using hardware with arithmetic functions and software for defining their operations. The security policy assignment apparatus may be constructed as an apparatus formed from a single chassis or as an apparatus formed from multiple chassis capable of communications.

The acquisition unit acquires data relating to the storage location of a digital document. A digital document refers to data (electronically organized information) expressing a document formed from characters or figures or photographs. The digital document may be formed from one sheet page or multiple sheet pages in a print image. If the digital document is formed from multiple sheets, all the pages are usually gathered into one file. Furthermore, the storage location of a digital document refers to the location where the digital document is stored (or held or saved). The storage location of a digital document typically is a storage location in a storage device, namely, the storage device where the digital document is stored or the location (directory) in the storage device. However, it may be an actual storage location, namely, the location of a building, floor or department. The data relating to the storage location directly represents the storage location or is mapped to the storage location.

The assignment unit sets a security policy to a digital document. During the setting process, correspondence data prepared in advance is referenced. The correspondence data maps the data relating to the storage location and the security policy setting. The correspondence data may be formed in a format (namely, as a prototype) based on the security policy to be assigned. There is no particular restriction as to where the correspondence data may be located. For example, the correspondence data may be stored as a file in a directory relating to the storage location or converted to another table that is mapped to each directory relating to the storage location. The security policy refers to management information defining the operating privileges for a digital document. Furthermore, operating privileges refer to the operations that can be performed with respect to a digital document, such as reading, writing, printing, transmitting, and so forth. The security policy can be set for every digital document or can be set for every user or user group. Thus, when setting the security policy, it is generally necessary to permit or prohibit multiple privileges for multiple users. The defining of these specific element values is referred to here as setting the security policy. The data relating to the storage location is mapped in the correspondence data to one or multiple (or even all) element values. The assignment unit sets the security policy to reflect the values defined from the data relating to the storage location and assigns it to the digital document. The assignment of the security policy is performed so as to ensure the effectiveness of the operating privileges in accordance with the security policy. This can be set in various ways. For example, modes can be illustrated where only those with privileges can perform encryption that can be decrypted or only those with privileges can provide a passable gate.

According to this mode, provided the user sets the correspondence data as necessary, an appropriate security policy for a digital document can be assigned without the user necessarily performing any subsequent special operation (although an operation, such as confirmation, can be performed as necessary). Since the storage location often reflects the nature of the digital document, setting the security policy on the basis of the data relating to the storage location makes it possible to protect the digital document with a security policy that reflects its nature. Then, by adopting the aforementioned mode, the burden of the task for setting the security policy for large quantities of digital documents in particular is reduced. The security policy assignment apparatus usually performs processing for digital documents that have not yet been assigned with a security policy. However, for example, the security policy assignment apparatus may be designed to reset the security policy for digital documents that have already been assigned.

In one mode of the security policy assignment apparatus of the present invention, a generation unit is included to scan a paper document and generate the digital document and to store the digital document to a set storage location. The digital document relating to the acquisition unit is a digital document generated and stored by the generation unit. Typically, the scanning function in the generation unit is implemented using a scanner. The scanner itself may occupy a single chassis or form a part of a multifunction device or a copying machine. In the latter case, integrating the acquisition unit or the assignment unit into the multifunction device or the copying machine is also effective. The storage location of the generated digital document may be automatically determined according to settings or may be determined on the basis of user command.

In one mode of the security policy assignment apparatus of the present invention, a reception unit is included to receive an input specifying a storage location and the assignment unit assigns a security policy to multiple digital documents stored in the received storage location. As a result, it becomes possible to assign a security policy at one time to some or all digital documents stored in the specified storage location. When assigning a security policy to certain digital documents, the criterion of whether to assign a security policy to a digital document can be determined by setting a selection condition, such as relating to file format or creation date of the digital document.

In one mode of the security policy assignment apparatus of the present invention, the data relating to the storage location is identification data indicating the storage location. Typically, data identifying a storage location in a storage device, such as storage device name or directory name, is used as identification data. However, it may be data identifying an actual storage location where the storage device is located, such as building name, floor name or department name. The identification data is often assigned to reflect the nature of the digital document to be stored and can be mapped to the security level to be achieved.

In one mode of the security policy assignment apparatus of the present invention, the correspondence data is stored in a storage location indicated by the identification data. Namely, the correspondence data is stored in the storage location, such as in a file format (naturally, the actual data may be anywhere within the storage device provided it can be identified as such). In this manner, the efficiency of the security policy assignment task is increased, such as by allowing a user to reference the contents in each storage location, and the factors contributing to user error can be expected to decrease.

In one mode of the security policy assignment apparatus of the present invention, the data relating to a storage location is attribute data assigned to the storage location. Examples of attribute data assigned to the storage location include data regarding access privileges of a user or group with respect to the storage location, such as storage device or directory, data regarding the administrator or owner of the storage location, data of the creation date of the storage location, and so forth. The attribute data assigned to the storage location often includes information intimately related to the security policy to be set and can be associated with the security level to be achieved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A security policy assignment apparatus comprising:
an acquisition unit that acquires data relating to a storage location of a digital document; and
an assignment unit that assigns a security policy, which has been set to correspond to data relating to the acquired storage location, with respect to the digital document by referencing correspondence data that maps data relating to the storage location and a security policy setting.

2. A security policy assignment apparatus according to claim 1, further comprising:
a generation unit that scans a paper document, generates a digital document, and stores the digital document to the set storage location;
the digital document obtained from the acquisition unit is generated and stored by the generation unit.

3. A security policy assignment apparatus according to claim 1, further comprising:
a reception unit that receives an input specifying the storage location;
the assignment unit assigns the security policy to a plurality of digital documents that are stored at the received storage location.

4. A security policy assignment apparatus according to claim 1, wherein:
the data relating to the storage location is identification data indicating the storage location.

5. A security policy assignment apparatus according to claim 4, wherein:
the correspondence data is stored at the storage location indicated by the identification data.

6. A security policy assignment apparatus according to claim 1, wherein:
the data relating to the storage location is attribute data assigned to the storage location.

7. A storage medium readable by computer, the storage medium storing a program of instructions executable by the computer to perform a security policy assignment process, the process comprising the steps of:
acquiring data relating to a storage location of a digital document; and
assigning a security policy, which has been set to correspond to data relating to the acquired storage location, with respect to the digital document by referencing correspondence data that maps data relating to the storage location and a security policy setting.

8. A storage medium according to claim 7, the process further comprising the steps of:
generating the digital document by scanning a paper document, and storing the digital document to the set storage location.

9. A storage medium according to claim 7, the process further comprising the steps of:
receiving an input specifying the storage location; and
assigning the security policy to a plurality of digital documents that are stored at the received storage location.

10. A storage medium according to claim 7, wherein:
the data relating to the storage location is identification data indicating the storage location.

11. A storage medium according to claim 10, wherein:
the correspondence data is stored in a storage location indicated by the identification data.

12. A storage medium according to claim 7, wherein:
the data relating to the storage location is attribute data assigned to the storage location.

13. A security policy assignment method, the method comprising the steps of:
acquiring data relating to a storage location of a digital document; and
assigning a security policy, which has been set to correspond to data relating to the acquired storage location, with respect to the digital document by referencing correspondence data that maps data relating to the storage location and a security policy setting.

14. A security policy assignment method according to claim 13, the method further comprising the steps of:
generating the digital document by scanning a paper document and storing the digital document to the set storage location.

15. A security policy assignment method according to claim 13, the method further comprising the steps of:
receiving an input specifying the storage location; and
assigning the security policy to a plurality of digital documents that are stored at the received storage location.

16. A security policy assignment method according to claim 13, wherein:
the data relating to the storage location is identification data indicating the storage location.

17. A security policy assignment method according to claim 16, wherein:
the correspondence data is stored in a storage location indicated by the identification data.

18. A security policy assignment method according to claim 13, wherein:
the data relating to the storage location is attribute data assigned to the storage location.
